(19) United States
(12) Patent Application Publication
(10) Pub. No.: US 2026/0244756 A1
(43) Pub. Date: Aug. 20, 2026

(54) SYSTEM AND METHOD FOR ARTIFICIAL INTELLIGENCE-BASED RISK ASSESSMENT AND SECURITY CONTROL OF DIGITAL ASSETS

(71) Applicant: The Toronto-Dominion Bank, Toronto (CA)

(72) Inventors: Cezar COZIANU, Mississauga (CA); Christopher R. TUMBIN, Cambridge (CA); Jason A. LINDSLEY, Voorhees, NJ (US); Aneerban CHAKRABORTY, Toronto (CA); Suraj ALAMONI, Toronto (CA); Kimberly Dawn HARROP, Toronto (CA); Holly Ann BAILEY, Brookhaven, PA (US)

(73) Assignee: The Toronto-Dominion Bank, Toronto (CA)

(21) Appl. No.: 19/058,208

(22) Filed: Feb. 20, 2025

(51) Int. Cl. G06F 21/57; G06F 21/40; G06F 21/53; G06F 21/62

(52) U.S. Cl. CPC G06F 21/577; G06F 21/40; G06F 21/53; G06F 21/6209; G06F 2221/034; G06F 2221/2141

(57) ABSTRACT

A computer system comprises at least one processor; and a memory coupled to the at least one processor and storing processor-executable instructions which, when executed by the at least one processor, configure the at least one processor to detect a change in digital asset security metadata for a digital asset; engage a trained artificial intelligence engine to generate a risk score for the digital asset based at least on the digital asset security metadata; and in response to determining that the risk score exceeds a predefined threshold, trigger security controls on the digital asset.

### TECHNICAL FIELD

The present application relates to systems and methods for artificial intelligence-based risk assessment and security control of digital assets.

### BACKGROUND

Traditional security frameworks often rely on static rule-based approaches or manual interventions, which are computationally inefficient and struggle to scale in dynamic threat environments. These systems require continuous rule updates and human oversight, leading to latency in threat detection and response. Additionally, existing security mechanisms may fail to dynamically assess risk based on real-time changes in asset security metadata, resulting in delayed or inadequate mitigation actions. The inability to efficiently process and analyze large volumes of security metadata in real-time further increases computational overhead, reducing the overall effectiveness of security operations.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 is a schematic diagram outlining various components of an artificial intelligence system;

FIG. 4 shows, in flowchart form, an example method for training an AI engine;

FIG. 5 shows, in flowchart form, an example method for AI-based risk assessment and security control of digital assets; and

FIG. 6 shows, in flowchart form, an example method for detecting a change in digital asset security metadata.

Like reference numerals are used in the drawings to denote like elements and features.

### DETAILED DESCRIPTION OF VARIOUS EMBODIMENTS

Accordingly, in one aspect there is provided a computer system comprising at least one processor; and a memory coupled to the at least one processor and storing processor-executable instructions which, when executed by the at least one processor, configure the at least one processor to detect a change in digital asset security metadata for a digital asset; engage a trained artificial intelligence engine to generate a risk score for the digital asset based at least on the digital asset security metadata; and in response to determining that the risk score exceeds a predefined threshold, trigger security controls on the digital asset.

In one or more embodiments, when detecting the change in the digital asset security metadata for the digital asset, the processor-executable instructions, when executed by the at least one processor, further configure the at least one processor to receive a real-time digital asset security metadata feed for the digital asset; and compare the real-time digital asset security metadata with previously obtained real-time digital asset security metadata to detect the change.

In one or more embodiments, the digital asset security metadata includes at least one of authentication mechanisms, encryption protocols, access control configurations, or vulnerability statuses.

In one or more embodiments, the trained artificial intelligence engine generates a domain risk score for at least one domain of risk for the digital asset.

In one or more embodiments, the at least one domain of risk includes at least one of confidentiality, integrity, or availability.

In one or more embodiments, the trained artificial intelligence engine determines the domain risk score based on at least one type of risk.

In one or more embodiments, the at least one type of risk includes at least one of external, internal or unintentional.

In one or more embodiments, the trained artificial intelligence engine generates the risk score for the digital asset by combining domain risk scores for all domains of risk.

In one or more embodiments, the processor-executable instructions, when executed by the at least one processor, configure the at least one processor to generate a set of training data that includes one or more risk scores determined for one or more digital assets and corresponding digital asset security metadata of the one or more digital assets; and train the artificial intelligence engine, using the set of training data, to generate the risk score for the digital asset based on the digital asset security metadata.

In one or more embodiments, the trigger security controls on the digital asset include at least one of restricting access to the digital asset, isolating the digital asset from a network, applying security patches to the digital asset, activating firewall rules to restrict communication with the digital asset, encrypting data stored on the digital asset, or initiating multi-factor authentication for access to the digital asset.

In one or more embodiments, the artificial intelligence engine includes an Extreme Gradient Boosting (XGBoost) model configured to perform regression tasks and generate the risk score for the digital asset based on the digital asset security metadata.

According to another aspect there is provided a computer-implemented method comprising detecting a change in digital asset security metadata for a digital asset; engaging a trained artificial intelligence engine to generate a risk score for the digital asset based at least on the digital asset security metadata; and in response to determining that the risk score exceeds a predefined threshold, triggering security controls on the digital asset.

In one or more embodiments, when detecting the change in the digital asset security metadata for the digital asset, the method further comprises receiving a real-time digital asset security metadata feed for the digital asset; and comparing the real-time digital asset security metadata with previously obtained real-time digital asset security metadata to detect the change.

In one or more embodiments, the digital asset security metadata includes at least one of authentication mechanisms, encryption protocols, access control configurations, or vulnerability statuses.

In one or more embodiments, the trained artificial intelligence engine generates a domain risk score for at least one domain of risk for the digital asset.

In one or more embodiments, the at least one domain of risk includes at least one of confidentiality, integrity, or availability.

In one or more embodiments, the trained artificial intelligence engine determines the domain risk score based on at least one type of risk.

In one or more embodiments, the at least one type of risk includes at least one of external, internal or unintentional.

In one or more embodiments, the trained artificial intelligence engine generates the risk score for the digital asset by combining domain risk scores for all domains of risk.

According to another aspect there is provided a non-transitory computer readable storage medium comprising computer-executable instructions which, when executed, configure at least one processor to detect a change in digital asset security metadata for a digital asset; engage a trained artificial intelligence engine to generate a risk score for the digital asset based at least on the digital asset security metadata; and in response to determining that the risk score exceeds a predefined threshold, trigger security controls on the digital asset.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of …or…” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

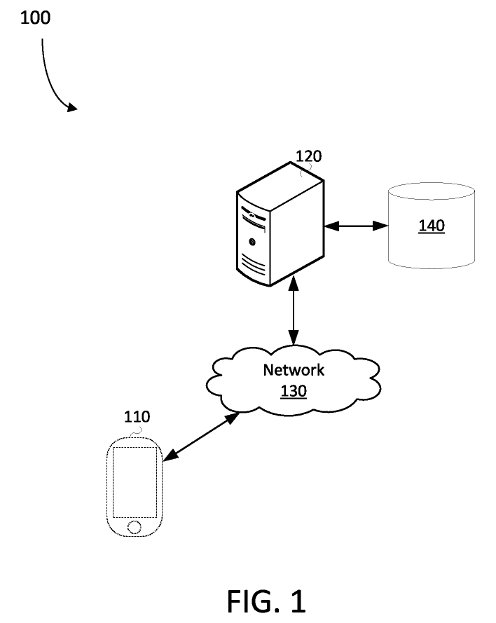

FIG. 1 is a schematic operation diagram illustrating an operating environment of an example embodiment. As shown, the system 100 includes a computing device 110 and a server 120 coupled to one another through a network 130, which may include a public network such as the Internet and/or a private network. The computing device 110 and the server 120 may be in geographically disparate locations. Put differently, the computing device 110 and the server 120 may be located remote from one another.

The computing device 110 may take a variety of forms including, for example, a mobile communication device such as a smartphone, a tablet computer, a wearable computer (such as a head-mounted display or smartwatch), a laptop or desktop computer, or a computing device of another type. The computing device 110 may store software instructions that cause the computing device 110 to establish communications with the server 120.

The server 120 is a computer system that may be associated with a financial institution. The server 120 is configured to maintain and manage a database 140, which stores financial and operational data, and supports the execution and storage of a variety of digital assets. These assets may include software applications, financial instruments, and other data-driven models. For example, server 120 may maintain a centralized inventory where digital assets, such as software applications and financial instruments, are registered, categorized, and tracked, ensuring efficient management of assets within the institution. The server may also execute digital assets that require computational resources, such as risk models or security protocols.

The server 120 is configured to host and execute an artificial intelligence (AI) system for performing AI-based risk assessments and triggering security controls for digital assets. As will be described in more detail, the AI system includes, among other modules, a trained AI engine capable of generating a risk score for digital assets based at least on digital asset security metadata, and a security controls trigger module that automatically activates security measures when the risk score exceeds a predefined threshold.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

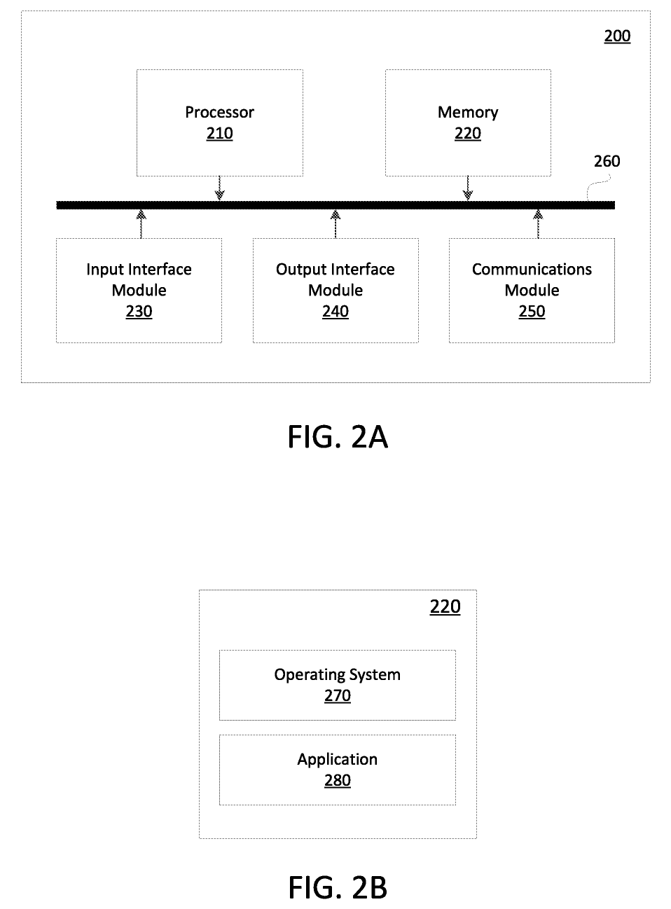

FIG. 2A is a high-level operation diagram of an example computer device 200. In some embodiments, the example computer device 200 may be exemplary of one or more of the computing device 110 and/or the server 120. The example computer device 200 includes a variety of modules. For example, as illustrated, the example computer device 200, may include a processor 210, a memory 220, an input interface module 230, an output interface module 240, and a communications module 250. As illustrated, the foregoing example modules of the example computer device 200 are in communication over a bus 260.

The processor 210 is a hardware processor. Processor 210 may, for example, be one or more ARM, Intel x86, PowerPC processors, or the like.

The memory 220 allows data to be stored and retrieved. The memory 220 may include, for example, random access memory, read-only memory, and persistent storage. Persistent storage may be, for example, flash memory, a solid-state drive, or the like. Read-only memory and persistent storage are a computer-readable medium. A computer-readable medium may be organized using a file system such as may be administered by an operating system governing overall operation of the example computer device 200.

The input interface module 230 allows the example computer device 200 to receive input signals. Input signals may, for example, correspond to input received from a user. The input interface module 230 may serve to interconnect the example computer device 200 with one or more input devices. Input signals may be received from input devices by the input interface module 230. Input devices may, for example, include a touchscreen input, keyboard, trackball, or the like. In some embodiments, all or a portion of the input interface module 230 may be integrated with an input device. For example, the input interface module 230 may be integrated with one of the aforementioned example input devices.

The output interface module 240 allows the example computer device 200 to provide output signals. Some output signals may, for example, allow provision of output to a user. The output interface module 240 may serve to interconnect the example computer device 200 with one or more output devices. Output signals may be sent to output devices by output interface module 240. Output devices may include, for example, a display screen such as for example, a liquid crystal display (LCD), a touchscreen display. Additionally, or alternatively, output devices may include devices other than screens such as for example a speaker, indicator lamps (such as for example light-emitting diodes (LEDs)), and printers. In some embodiments, all or a portion of the output interface module 240 may be integrated with an output device. For example, the output interface module 240 may be integrated with one of the aforementioned example output devices.

The communications module 250 allows the example computer device 200 to communicate with other electronic devices and/or various communications networks. For example, the communications module 250 may allow the example computer device 200 to send or receive communications signals. Communications signals may be sent or received according to one or more protocols or according to one or more standards. For example, the communications module 250 may allow the example computer device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 250 may allow the example computer device 200 to communicate using near-field communication (NFC), via Wi-Fi (TM), using Bluetooth (TM) or via some combination of one or more networks or protocols. Contactless payments may be made using NFC. In some embodiments, all or a portion of the communications module 250 may be integrated into a component of the example computer device 200. For example, the communications module may be integrated into a communications chipset.

Software comprising instructions is executed by the processor 210 from a computer-readable medium. For example, software may be loaded into random-access memory from persistent storage of memory 220. Additionally, or alternatively, instructions may be executed by the processor 210 directly from read-only memory of memory 220.

FIG. 2B depicts a simplified organization of software components stored in memory 220 of the example computer device 200. As illustrated these software components include an operating system 270 and an application 280.

The operating system 270 is software. The operating system 270 allows the application 280 to access the processor 210, the memory 220, the input interface module 230, the output interface module 240 and the communications module 250. The operating system 270 may be, for example, Apple iOS^{TM}, Google Android^{TM}, Linux^{TM}, Microsoft Windows^{TM}, or the like.

The application 280 adapts the example computer device 200, in combination with the operating system 270, to operate as a device performing specific functions. It will be appreciated that although a single application 280 is shown, in operation the memory 220 may include more than one application 280 and different applications 280 may perform different operations.

As mentioned, the server 120 is configured to host and execute an AI system for performing AI-based risk assessments and triggering security controls for digital assets. As will be described in more detail, the AI system includes, among other modules, a trained AI engine capable of generating a risk score for digital assets based at least on digital asset security metadata, and a security controls trigger module that activates predefined security measures when the risk score exceeds a predefined threshold. The AI engine may utilize various types of metadata, such as authentication mechanisms, encryption protocols, and access control configurations, to evaluate and assess risk. Upon determining that the risk score for a digital asset exceeds an acceptable risk threshold, the server 120 triggers security controls such as isolating the asset from the network, restricting access, or applying security patches to mitigate the identified risks.

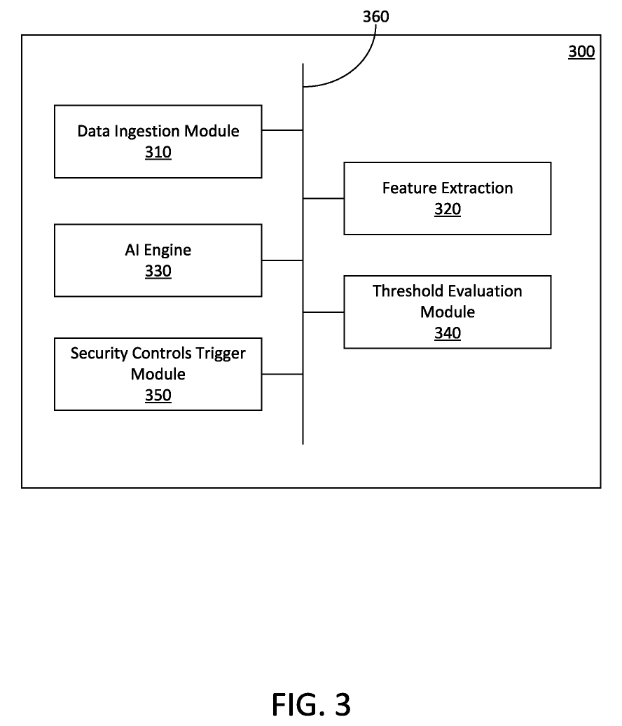

As mentioned, the server 120 is configured to host and execute an AI system for performing AI-based risk assessments and triggering security controls for digital assets where the AI system includes, among other modules, a trained AI engine capable of generating a risk score for digital assets based at least on digital asset security metadata, and a security controls trigger module that automatically activates security measures when the risk score exceeds a predefined threshold. FIG. 3 is an example schematic diagram outlining various components of AI system 300. As can be seen, the AI system 300 includes a data ingestion module 310, a feature extraction module 320, an AI engine 330, a threshold evaluation module 340, and a security controls trigger module 350. The various modules communicate with one another over a pipeline 360. The AI system utilizes the interconnected modules to detect changes in digital asset security metadata, generate risk scores, and trigger security controls.

The data ingestion module 310 is configured to collect, normalize, and store digital asset security metadata received from multiple sources. The sources may include vulnerability scanners, security information and event management systems, patch management tools, cloud security services, etc. The digital asset security metadata may include, for example, authentication protocols, encryption standards, access control configurations, vulnerability statutes, and other relevant security attributes of digital assets. The data ingestion module 310 may receive real-time digital asset security metadata feeds for digital assets. The data ingestion module 310 ensures a continuous flow of up-to-date digital asset security metadata which may be used by subsequent modules in the AI system 300.

The feature extraction module 320 processes the real-time digital asset security metadata ingested by the data ingestion module 310. Specifically, the feature extraction module 320 extracts relevant features from the real-time digital asset security metadata. The relevant features may include authentication mechanisms (e.g. multi-factor authentication), encryption methods or protocols (e.g. AES-256), access control configurations (e.g. role-based access control), patch status (e.g. whether a digital asset is up-to-date with the latest patches), and vulnerability statutes, etc. The extracted features are prepared and formatted for input into the AI engine 330.

The AI engine 330 is trained to generate a risk score for a digital asset based at least on the digital asset security metadata. In one or more embodiments, the AI engine 330 may include an Extreme Gradient Boosting (XGBoost) model configured to perform regression tasks and generate a risk score for a digital asset based at least on the digital asset security metadata. The digital asset security metadata may include the extracted features prepared and formatted by the feature extraction module 320.

In one or more embodiments, the AI engine 330 may evaluate the digital asset across three primary domains of risk: confidentiality, integrity, and availability.

Confidentiality risks may arise when digital assets are exposed to unauthorized access or data leaks. These risks may arise due to weak encryption, misconfigured permissions, or unprotected data transmissions. For example, storing sensitive data in an unencrypted format or allowing excessive user privileges increases the likelihood of unauthorized access. Cloud misconfigurations and vulnerabilities in authentication systems may also contribute to confidentiality risks. Cyberattacks, such as phishing, malware, and insider threats, exploit these weaknesses to extract confidential information.

In one or more embodiments, in evaluating confidentiality, the AI engine 330 may analyze the digital asset security metadata such as for example access control lists, user permissions, encryption details, and audit logs that track who accessed or attempted to access a digital asset. For example, the AI engine 330 may analyze the digital asset security metadata to determine whether a digital asset has proper access restrictions (e.g. role-based access control), if sensitive data is encrypted at rest and in transit (e.g. digital asset security metadata indicating AES-256 encryption for stored files), whether authentication mechanism such as multi-factor authentication and session expiration settings are enforced, to identify anomalous access patterns in log metadata, such as unusual login times or multiple failed authentication attempts, which may indicate unauthorized access attempts. Weak or misconfigured digital asset security metadata may increase the risk of unauthorized access leading to confidentiality breaches.

Integrity risks may arise when digital assets are modified, corrupted, or manipulated without authorization. Integrity risks may arise due to software bugs, inadequate validation mechanisms, or intentional attacks that alter data records. For example, if a database lacks cryptographic integrity checks, unauthorized changes may go undetected, leading to fraud. Malware such as ransomware may encrypt or alter critical files, disrupting normal operations. Supply chain attacks, such as for example where malicious code is inserted into software updates, may pose integrity risks by compromising systems at the source. Improper access controls on log files may lead to unauthorized modifications.

In one or more embodiments, in evaluating integrity, the AI engine 330 may analyze the digital asset security metadata to check hash values and cryptographic checksums to confirm that files and databases have not been altered, review log metadata for unexpected changes, such as unauthorized modifications to configuration files or database records, analyze version control metadata to ensure that only authorized updates are applied, and may monitor file integrity monitoring logs to help detect unauthorized alterations. If integrity-related digital asset security metadata is missing or shows unexpected modifications, this may signal a potential compromise such as for example unauthorized tampering or malware activity.

Availability risks may arise when digital assets become inaccessible due to cyberattacks, system failures, or resource exhaustion. Distributed Denial-of-Service (DDoS) attacks flood servers with excessing requests, making applications and services unavailable. Poor infrastructure planning, such as a lack of redundancy or improper load balancing, may cause performance bottlenecks, leading to outages during high-demand periods. Ransomware attacks that encrypt critical system files or databases may lock out legitimate users. Further, hardware failures, misconfigured firewalls, or unexpected crashes may contribute to availability risks, disrupting essential operations.

In one or more embodiments, in evaluating availability, the AI engine 330 may analyze the digital asset security metadata such as for example server and network uptime logs to identify patterns or service interruptions or excessive downtime, performance monitoring metadata, including CPU, memory, and bandwidth usage, to detect potential resource exhaustion or signs of a DDoS attack, disaster recovery and failover metadata, ensuring backup systems and redundancy mechanisms are in place, incident response logs to assess how quickly the server recovers from failures or cyberattacks. Digital asset security metadata gaps, such as missing redundancy configurations or unmonitored performance metrics, increase the likelihood of availability disruptions.

Within each of the three primary domains of risk, the AI engine 330 evaluates three types of risk: external, internal, and unintentional.

External risks may arise from sources outside an organization. External risks are often posed by malicious actors or third-party vulnerabilities.

External risks to confidentiality may include cyberattacks such as hacking attempts, phishing campaigns, or data breaches originating from external threats. For example, an attacker exploiting vulnerability of a digital asset may gain unauthorized access to sensitive data. The AI engine 330 may analyze the digital asset security metadata for indicators such as unapproved IP access, suspicious login attempts from foreign countries, and external malware signatures.

External risks to integrity may result from malware, cyberattacks, or tampering by individuals or organizations outside the system. Examples may include DDoS attacks targeting a digital asset to disrupt service or malicious software introduced into the system via third-party software. The AI engine 330 may check for unusual traffic patterns or unexpected software updates originating from external sources.

External risks to availability may involve attacks like DDoS which can overwhelm a system and cause service disruptions. The AI engine 330 may analyze the digital asset security metadata relating to network traffic patterns, sudden increase in resource requests, and disruptions in service that may indicate an external attack.

Internal risks may arise from within an organization, typically involving employees, contractors, or insiders with legitimate access to digital assets. Internal risks may be malicious or unintentional but often are tied to inadequate controls or oversight.

Internal risks to confidentiality may involve employees intentionally leaking sensitive data or accidentally sharing sensitive data with unauthorized parties. The AI engine 330 may analyze the digital asset security metadata, such as access logs or permission changes, to detect suspicious internal behavior.

Internal risks to integrity may be caused by unauthorized changes to digital assets by employees or contractors, often without malicious intent. The AI engine 330 may analyze the digital asset security metadata such as version control logs, configuration file changes, and incident response logs to detect unauthorized modifications.

Internal risks to availability may come from poorly planned resource allocation or internal system failures. The AI engine 330 may analyze the digital asset security metadata such as for example system and network performance metrics to identify internal failures or inefficiencies that may affect service availability such as for example inadequate resource allocation or incorrect configuration of redundancy features.

Unintentional risks may result from accidental actions or errors that were not intended to cause harm. These risks are often a byproduct of human error or unforeseen technical failures.

Unintentional risks to confidentiality may arise from situations such as an employee accidentally sending sensitive data to the wrong recipient or improperly configuring data storage systems leading to unintended exposure. The AI engine 330 may analyze the digital asset security metadata such as access logs, permissions configuration, and error logs to detect accidental misconfigurations.

Unintentional risks to integrity may occur when a digital asset’s data is corrupted or altered due to human error or faulty software. The AI engine 330 may analyze the digital asset security metadata such as file integrity logs, backup metadata, and version control data to ensure there are no unintended modifications or data loss.

Unintentional risks to availability may occur from operational mistakes or hardware failures. The AI engine 330 may analyze the digital asset security metadata such as for example uptime logs, resource consumption metrics, and incident response logs to detect performance issues or unexpected downtime caused by accidental causes.

As mentioned, the AI engine 330 may include an XGBoost model configured to perform regression tasks and generate a risk score for a digital asset based at least on the digital asset security metadata. In one or more embodiments, the AI engine 330 may generate a domain risk score for at least one domain of risk for the digital asset. For example, the domains of risk may include confidentiality, integrity, and/or availability. As such, the AI engine 330 may generate a domain risk score for each of these domains of risk.

In one or more embodiments, the AI engine 330 may determine the domain risk score based on at least one type of risk. For example, the types of risk may include external, internal, and/or unintentional. As such, the AI engine 330 may generate a risk score for each of these types of risk. For each domain of risk, the AI engine 330 may select the highest risk score from the three types of risk (external, internal, unintentional) as the domain risk score.

Put another way, the AI engine 330 may be configured to generate, for each domain of risk (confidentiality, integrity, availability), a risk score for each type of risk (external, internal, unintentional). For each domain of risk, the highest risk score from the three types of risk may be selected as the domain risk score.

In one or more embodiments, the risk score for each type of risk may include a numerical value between 0 and 5, where 0 indicates low risk and 5 indicates high risk. Of course, the numerical values may be defined in other manners such as for example between 0 and 1 or between 0 and 10.

In one or more embodiments, the AI engine 330 may combine the three domain scores to generate an overall risk score for the digital asset. For example, the highest risk score for each domain of risk may be summed together to generate an overall risk score for the digital asset. As another example, the highest risk score for each domain of risk may be combined to determine an average risk score and this may be set as the overall risk score of the digital asset. As yet another example, all risk scores for all domains of risk may be combined to determine an average risk score and this may be set as the overall risk score of the digital asset.

The overall risk score for the digital asset is sent to the threshold evaluation module 340.

The threshold evaluation module 340 compares the overall risk score of the digital asset to a predefined threshold that represents an acceptable risk level. For example, if the risk score exceeds or is equal to the predefined threshold, the threshold evaluation module 340 may flag the digital asset as being at elevated risk and this may trigger the security controls trigger module 350. Of course, if the risk score is below the predefined threshold, no action may be required.

The threshold evaluation module 340 may utilize thresholding where various thresholds may be predefined and this may be done to trigger different types of security responses. For example, a score above 4 may trigger a high-priority action while a score above 2 but below 4 may trigger a moderate response.

The security controls trigger module 350 is configured to trigger security controls to mitigate identified risks. These controls may include actions such as restricting access to the digital asset, isolating the digital asset from a network, applying security patches to the digital asset, activating firewall rules to restrict communication with the digital asset, encrypting data stored on the digital asset, and/or initiating multi-factor authentication for access to the digital asset. It will be appreciated that other security controls may be triggered to mitigate identified risks.

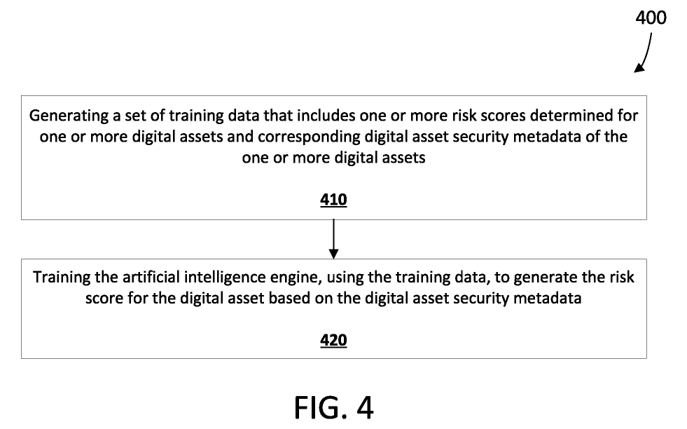

As mentioned, the AI engine 330 is trained to generate a risk score for a digital asset based at least on the digital asset security metadata. Reference is made to FIG. 4, which illustrates, in flowchart form, a method 400 for training the AI engine 330. The method 400 may be implemented by a computing device having suitable processor-executable instructions for causing the computing device to carry out the described operations. The method 400 may be implemented, in whole or in part, by the server 120.

The method 400 includes generating a set of training data that includes one or more risk scores determined for one or more digital assets and corresponding digital asset security metadata of the one or more digital assets (step 410).

The one or more risk scores determined for the one or more digital assets may be obtained from the database and/or one or more other sources. For example, at least some of the training data may include historical risk scores and corresponding digital asset security metadata collected from sources such as for example vulnerability scanners, configuration management tools, etc. At least some of the training data may include historical data that include risk scores assigned to digital assets based on previous evaluations and the corresponding digital asset security metadata at the time of scoring. At least some of the training data may include historical data that include risk scores manually assigned to digital assets based on previous manual evaluations and the corresponding digital asset security metadata at the time of scoring.

In one or more embodiments, at least some of the training data may be generated by simulating changes to digital asset security metadata and assigning risk scores to the changed digital asset security metadata. This type of training data may be referred to as simulated training data. For example, one or more simulation models may be utilized to apply various changes to digital asset security metadata such as digital asset type, patch levels, access controls, and exposure threats. These changes may be randomized within a defined range or based on real-world patterns. Once the changes to the digital asset security metadata have been made and new digital asset security metadata is generated, risk scores may be calculated using predefined risk models. This may allow for the creation of new, realistic training samples without relying on manually scored data which may be prone to human error or may lack consistency. By simulating digital asset security metadata changes and updating risk scores dynamically, a robust and accurate set of training data may be generated that reflects evolving security landscapes, improving model accuracy and reliability over time.

The set of training data may include a combination of simulated training data and real-world training data.

The set of training data may include a risk score for one or more domains of risk (confidentiality, integrity, availability) and/or a risk score for one or more types of risk (external, internal, unintentional) within one or more domains of risk.

The method 400 includes training the AI engine, using the set of training data, to generate the risk score for the digital asset based on the digital asset security metadata (step 420).

Using the set of training data, the AI engine 330 may be trained with an XGBoost regression model to predict risk scores for digital assets based on the digital asset security metadata. During training, the AI engine 330 is trained to learn the patterns and relationships between extracted features (such as access control configurations, patch status, and authentication methods) and the risk scores assigned to the digital assets. The regression task enables the AI engine 330 to predict continuous risk scores that reflect the likelihood of the different types of risk (external, internal, unintentional) within each domain (confidentiality, integrity, availability).

The AI engine 330 may be trained to generate, for each domain of risk (confidentiality, integrity, availability), a risk score for each type of risk (external, internal, unintentional). For each domain of risk, the AI engine 330 may be trained to select the highest risk score from the three types of risk as the domain risk score.

In one or more embodiments, the AI engine 330 may be trained to combine the three domain scores to generate an overall risk score for the digital asset. For example, the highest risk score for each domain of risk may be summed together to generate an overall risk score for the digital asset. As another example, the highest risk score for each domain of risk may be combined to determine an average risk score and this may be set as the overall risk score of the digital asset. As yet another example, all risk scores for all domains of risk may be combined to determine an average risk score and this may be set as the overall risk score of the digital asset.

The training may be iteratively refined to minimize error, ensuring that the AI engine 330 can accurately generate risk scores for new, unseen data. Once the AI engine 330 is trained and validated against a separate training dataset, the AI engine 330 may be deployed to make real-time predictions based on incoming digital asset metadata.

The AI engine 330 may be periodically retrained using fresh training data in manners similar to that described with reference to the method 400. Retraining allows the AI engine 330 to continuously learn from new patterns, emerging threats, and evolving risk factors. By incorporating updated training data, the AI engine 330 may refine its predictive accuracy and enhance its ability to identify and mitigate security risks in real-time. As a result, the AI engine 330 may remain adaptive, resilient, and effective in responding to dynamic threat landscapes while maintaining computational efficiency.

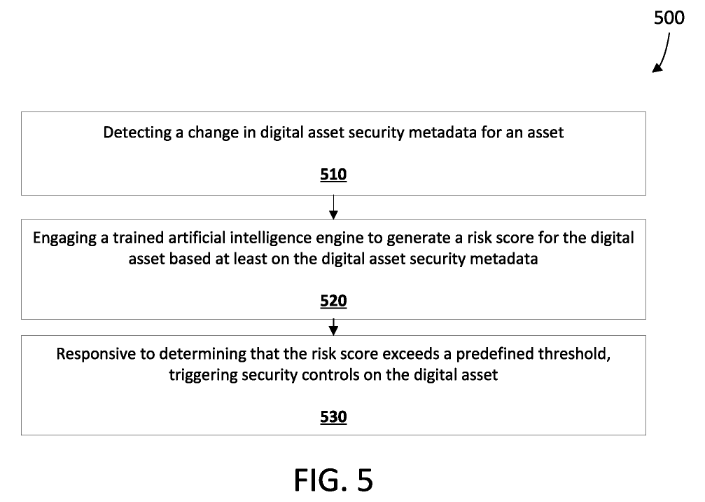

Reference is made to FIG. 5, which illustrates, in flowchart form, a method 500 for AI-based risk assessment and security control of digital assets. The method 500 may be implemented by a computing device having suitable processor-executable instructions for causing the computing device to carry out the described operations. The method 500 may be implemented, in whole or in part, by the server 120. At least some of the operations may be performed by one or more modules of the AI system 300.

The method 500 includes detecting a change in digital asset security metadata for a digital asset (step 510).

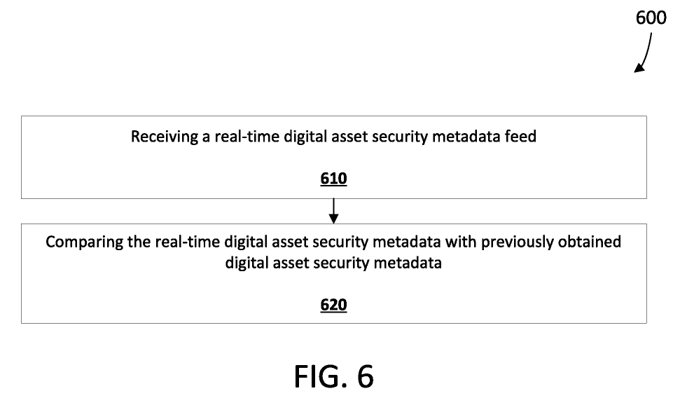

To detect the change in the digital asset security metadata, a method 600 may be performed. Reference is made to FIG. 6, which illustrates, in flowchart form, a method 600 for detecting the change in the digital asset security metadata. The method 600 may be implemented by a computing device having suitable processor-executable instructions for causing the computing device to carry out the described operations. The method 600 may be implemented, in whole or in part, by the server 120. At least some of the operations may be performed by one or more modules of the AI system 300 such as for example the data ingestion module 310.

The method 600 includes receiving a real-time digital asset security metadata feed (step 610).

A real-time digital asset security metadata feed may be received. For example, as mentioned, the data ingestion module 310 may be configured to receive the real-time digital asset security metadata feed for a digital asset. The digital asset security metadata stream may be analyzed to extract an identifier of the digital asset.

As mentioned, the data ingestion module 310 may collect, normalize, and store the digital asset security metadata received from multiple sources. The sources may include vulnerability scanners, security information and event management systems, patch management tools, cloud security services, etc. The digital asset security metadata may include, for example, authentication protocols, encryption standards, access control configurations, vulnerability statutes, and other relevant security attributes of digital assets. The data ingestion module 310 may receive real-time digital asset security metadata feeds for digital assets.

In one or more embodiments, the feature extraction module 320 may be engaged to process the real-time digital asset security metadata ingested by the data ingestion module 310 to extract relevant features therefrom. For example, as mentioned, the relevant features may include authentication mechanisms (e.g. multi-factor authentication), encryption methods (e.g. AES-256), access control configurations (e.g. role-based access control), patch status (e.g. whether a digital asset is up-to-date with the latest patches), and vulnerability information.

The method 600 includes comparing the real-time digital asset security metadata with previously obtained digital asset security metadata (step 620).

In one or more embodiments, the digital asset security metadata may include an identifier of the digital asset. The server 120 may maintain a database that includes a list of identifiers of digital assets and may store digital asset security metadata in association with the identifiers. As such, the identifier may be used to retrieve the previously obtained digital asset security metadata and this may include digital asset security metadata previously collected, normalized and stored by the data ingestion module 310.

In one or more embodiments, the extracted features of the digital asset security metadata may be compared to previously extracted features of the previously obtained digital asset security metadata. For example, as mentioned, relevant features may include authentication mechanisms (e.g. multi-factor authentication), encryption methods or protocols (e.g. AES-256), access control configurations (e.g. role-based access control), patch status (e.g. whether a digital asset is up-to-date with the latest patches), and vulnerability statutes, etc. and these features may be compared to the previously extracted features of the previously obtained digital asset security metadata to detect the change in the digital asset security metadata.

In one or more embodiments, the identifier of the digital asset may not be found in the list of identifiers and as such the change in digital asset security metadata may include a determination that the digital asset is a new digital asset. As such, operations may be performed to add the new digital asset to the database and may store the digital asset security metadata in association with the identifier of the new digital asset.

The change in the digital asset security metadata may be detected based on the comparison of the real-time digital asset security metadata (or features extracted therefrom) and the previously obtained digital asset security metadata (or features extracted therefrom). The change in the digital asset security metadata may alternatively be detected when it is determined that the digital asset is a new digital asset.

The method 500 includes engaging a trained AI engine to generate a risk score for the digital asset based at least on the digital asset security metadata (step 520).

Responsive to detecting the change in the digital asset security metadata, the AI system 300 is engaged to generate a risk score for the digital asset based at least on the digital asset security metadata. Specifically, the trained AI engine 330 of the AI system 300 is engaged.

As mentioned, the feature extraction module 320 may extract relevant features from the real-time digital asset security metadata and may prepare and format the extracted features for input into the AI engine 330. As such, the prepared and formatted extracted features may be provided as input to the AI engine 330 and the AI engine 330 may generate a risk score for the digital asset based on this input.

As mentioned, the AI engine 330 may include an XGBoost model configured to perform regression tasks and generate a risk score for a digital asset based at least on the digital asset security metadata. In one or more embodiments, the AI engine 330 may generate a domain risk score for at least one domain of risk for the digital asset. For example, as described herein, the domains of risk may include confidentiality, integrity, and/or availability. As such, the AI engine 330 may generate a domain risk score for each of these domains of risk.

In one or more embodiments, the AI engine 330 may determine the domain risk score based on at least one type of risk. For example, as described herein, the types of risk may include external, internal, and/or unintentional. As such, the AI engine 330 may generate a risk score for each of these types of risk. For each domain of risk, the AI engine 330 may select the highest risk score from the three types of risk (external, internal, unintentional) as the domain risk score.

As mentioned, the AI engine 330 may combine the three domain scores to generate an overall risk score for the digital asset. For example, the highest risk score for each domain of risk may be summed together to generate an overall risk score for the digital asset. As another example, the highest risk score for each domain of risk may be combined to determine an average risk score and this may be set as the overall risk score of the digital asset. As yet another example, all risk scores for all domains of risk may be combined to determine an average risk score and this may be set as the overall risk score of the digital asset.

The method 500 includes, in response to determining that the risk score exceeds a predefined threshold, trigger security controls on the digital asset (step 530).

In one or more embodiments, within the AI system 300, the risk score generated by the AI engine 330 may be sent to the threshold evaluation module 340 to determine whether the risk score exceeds a predefined threshold.

As mentioned, the threshold evaluation module 340 may compare the overall risk score of the digital asset to a predefined threshold that represents an acceptable risk level. For example, if the risk score exceeds or is equal to the predefined threshold, the threshold evaluation module 340 may flag the digital asset as being at elevated risk and this may trigger security controls on the digital asset. Of course, if the risk score is below the predefined threshold, no action may be required.

The threshold evaluation module 340 may utilize thresholding where various thresholds may be predefined and this may be done to trigger different types of security responses. For example, a score above 4 may trigger a high-priority action while a score above 2 but below 4 may trigger a moderate response.

Responsive to determining that the risk score exceeds the predefined threshold, the security controls trigger module 350 may be engaged to trigger security controls on the digital asset to mitigate identified risks. In one or more embodiments, the security controls on the digital asset may include restricting access to the digital asset, isolating the digital asset from a network, applying security patches to the digital asset, activating firewall rules to restrict communication with the digital asset, encrypting data stored on the digital asset, and/or initiating multi-factor authentication for access to the digital asset.

As one example, upon detecting that the risk score is above the predefined threshold, an automated access control policy may be applied using an identity and access management system. For example, the identity and access management system may automatically revoke access permissions for systems that do not meet specific security criteria such as for example those not using multi-factor authentication or those located in high-risk regions.

As another example, upon detecting that the risk score is above the predefined threshold, the digital asset may be automatically isolated by adjusting network configurations. For example, the server 120 may apply a network segmentation rule to place the digital asset into a quarantine local area network (LAN) or subnet that prevents any further inbound or outbound network traffic except for specific remediation tools or monitoring systems.

As yet another example, upon detecting that the risk score is above the predefined threshold, a vulnerability management system may be integrated to automatically trigger patch deployment. Specifically, upon detection of outdated software versions or unpatched vulnerabilities on the digital asset, the server 120 may pull the latest security patches from a centralized repository and apply them in a rolling manner to minimize potential downtime of the digital asset.

The proactive and automated steps described herein may help mitigate risks in real-time, ensuring that response times are reduced and that digital assets are protected without relying on manual interventions that may be delayed on error-prone.

In one or more embodiments described herein, the AI engine 330 is described as combining the three domain risk scores to generate an overall risk score for a digital asset. It will be appreciated that the risk score used for analysis of the digital assets may be defined in different manners. For example, all three domain risk scores may be compared to predefined domain risk score thresholds to determine whether or not security controls are required on the digital asset. As another example, the risk score for all risk types for all domains of risk may be used. In these embodiments the risk score or risk scores identified as being above the predefined threshold(s) may be used to select which security controls are to be triggered for the digital asset. For example, one or more modules of the AI system 300 may maintain a mapping of risk types within each domain of risk and security controls that are to be triggered in response to determining that the risk score for a particular risk type within a particular risk domain is above a particular predefined threshold.

In manners described herein, computer resource efficiency is improved by automating and optimizing risk assessment for digital assets. Traditional risk management approaches often rely on manual input or batch processing, resulting in periods of inactivity or excessive resource allocation. In contrast, the systems and methods described herein leverage real-time data ingestion and automated decision-making, enabling continuous risk evaluation while minimizing unnecessary computational overhead.

In manners described herein, an efficient machine learning model, XGBoost, is utilized due to its high computational speed and low memory usage. This model generates risk scores based on real-time digital asset metadata. Risk scores are only generated in response to changes in digital asset metadata, reducing server load by avoiding redundant checks on unchanged assets.

In manners described herein, feature extraction may be performed prior to engaging the AI engine to process only the most relevant digital asset security metadata. By focusing on features that directly impact the asset’s risk profile, computational resources are used more efficiently. This streamlined approach minimizes processing overhead while enabling real-time decision-making without compromising accuracy or performance.

In manners described herein, security controls are triggered based on accurate, real-time risk predictions, mitigating downstream errors and potential attacks.

In manners described herein, risk scores are calculated in real time, and security actions are only triggered when the risk score exceeds a predefined threshold. This prevents unnecessary interventions that may be computationally expensive or disruptive. The systems and methods described herein improve upon traditional security models that rely on broad, blanket security measures, which often result in false positives and inefficient use of resources. By reducing false positives and prioritizing high-risk events, security controls are applied only when necessary, optimizing computational efficiency and preventing unnecessary disruptions. This targeted approach lowers the computational cost associated with widespread security measures while also reducing the risk of downstream errors caused by excessive or unwarranted security actions.

Further, the systems and methods described herein continuously learn from historical and real-time data, adapting to emerging threats. This ensures that security responses remain relevant and resource-conscious, further reducing the likelihood of computationally expensive errors or attacks.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computer system comprising:
at least one processor; and
a memory coupled to the at least one processor and storing processor-executable instructions which, when executed by the at least one processor, configure the at least one processor to:
detect a change in digital asset security metadata for a digital asset;
engage a trained artificial intelligence engine to generate a risk score for the digital asset based at least on the digital asset security metadata; and
in response to determining that the risk score exceeds a predefined threshold, trigger security controls on the digital asset.

2. The computer system of claim 1, wherein when detecting the change in the digital asset security metadata for the digital asset, the processor-executable instructions, when executed by the at least one processor, further configure the at least one processor to:
receive a real-time digital asset security metadata feed for the digital asset; and
compare the real-time digital asset security metadata with previously obtained real-time digital asset security metadata to detect the change.

3. The computer system of claim 1, wherein the digital asset security metadata includes at least one of authentication mechanisms, encryption protocols, access control configurations, or vulnerability statuses.

4. The computer system of claim 1, wherein the trained artificial intelligence engine generates a domain risk score for at least one domain of risk for the digital asset.

5. The computer system of claim 4, wherein the at least one domain of risk includes at least one of confidentiality, integrity, or availability.

6. The computer system of claim 4, wherein the trained artificial intelligence engine determines the domain risk score based on at least one type of risk.

7. The computer system of claim 6, wherein the at least one type of risk includes at least one of external, internal or unintentional.

8. The computer system of claim 1, wherein the trained artificial intelligence engine generates the risk score for the digital asset by combining domain risk scores for all domains of risk.

9. The computer system of claim 1, wherein the processor-executable instructions, when executed by the at least one processor, configure the at least one processor to:
generate a set of training data that includes one or more risk scores determined for one or more digital assets and corresponding digital asset security metadata of the one or more digital assets; and
train the artificial intelligence engine, using the set of training data, to generate the risk score for the digital asset based on the digital asset security metadata.

10. The computer system of claim 1, wherein the trigger security controls on the digital asset include at least one of restricting access to the digital asset, isolating the digital asset from a network, applying security patches to the digital asset, activating firewall rules to restrict communication with the digital asset, encrypting data stored on the digital asset, or initiating multi-factor authentication for access to the digital asset.

11. The computer system of claim 1, wherein the artificial intelligence engine includes an Extreme Gradient Boosting (XGBoost) model configured to perform regression tasks and generate the risk score for the digital asset based on the digital asset security metadata.

12. A computer-implemented method comprising:
detecting a change in digital asset security metadata for a digital asset;
engaging a trained artificial intelligence engine to generate a risk score for the digital asset based at least on the digital asset security metadata; and
in response to determining that the risk score exceeds a predefined threshold, triggering security controls on the digital asset.

13. The computer-implemented method of claim 12, wherein when detecting the change in the digital asset security metadata for the digital asset, the method further comprises:
receiving a real-time digital asset security metadata feed for the digital asset; and
comparing the real-time digital asset security metadata with previously obtained real-time digital asset security metadata to detect the change.

14. The computer-implemented method of claim 12, wherein the digital asset security metadata includes at least one of authentication mechanisms, encryption protocols, access control configurations, or vulnerability statuses.

15. The computer-implemented method of claim 12, wherein the trained artificial intelligence engine generates a domain risk score for at least one domain of risk for the digital asset.

16. The computer-implemented method of claim 15, wherein the at least one domain of risk includes at least one of confidentiality, integrity, or availability.

17. The computer-implemented method of claim 16, wherein the trained artificial intelligence engine determines the domain risk score based on at least one type of risk.

18. The computer-implemented method of claim 16, wherein the at least one type of risk includes at least one of external, internal or unintentional.

19. The computer-implemented method of claim 12, wherein the trained artificial intelligence engine generates the risk score for the digital asset by combining domain risk scores for all domains of risk.

20. A non-transitory computer readable storage medium comprising computer-executable instructions which, when executed, configure at least one processor to:
detect a change in digital asset security metadata for a digital asset;
engage a trained artificial intelligence engine to generate a risk score for the digital asset based at least on the digital asset security metadata; and
in response to determining that the risk score exceeds a predefined threshold, trigger security controls on the digital asset.
